(19) United States
(12) Patent Application Publication
(10) Pub. No.: US 2014/0003308 A1
(43) Pub. Date: Jan. 2, 2014

(54) PHYSICAL-LAYER DEVICE CONFIGURABLE FOR TIME-DIVISION DUPLEXING AND FREQUENCY-DIVISION DUPLEXING

(71) Applicant: QUALCOMM INCORPORATED, San Diego, CA (US)

(72) Inventors: Nicola Varanese, Nuremberg (DE); Christian Pietsch, Nuremberg (DE); Juan Montojo, Nuremberg (DE); Andrea Maria Garavaglia, Nuremberg (DE)

(73) Assignee: QUALCOMM Incorporated, San Diego, CA (US)

(21) Appl. No.: 13/796,869

(22) Filed: Mar. 12, 2013

Related U.S. Application Data
(60) Provisional application No. 61/667,168, filed on Jul. 2, 2012.
(60) Provisional application No. 61/675,112, filed on Jul. 24, 2012.
(60) Provisional application No. 61/702,195, filed on Sep. 17, 2012.

(51) Int. Cl. H04J 4/00

(52) U.S. Cl. CPC H04J 4/005
USPC 370/294

(57) ABSTRACT

A physical-layer device includes a first sublayer to receive a first continuous bitstream from a media-independent interface and to provide a second continuous bitstream to the media-independent interface. The physical-layer device also includes a second sublayer to transmit first signals corresponding to the first continuous bitstream and to receive second signals corresponding to the second continuous bitstream. The second sublayer is to transmit the first signals and receive the second signals using time-division duplexing in a first mode of operation and using frequency-division duplexing in a second mode of operation.

### RELATED APPLICATIONS

This application claims priority to U.S. Provisional Patent Applications No. 61/667,168, titled “Physical-Layer Device Configurable for Implementing Time-Division Duplexing and Frequency-Division Duplexing,” filed Jul. 2, 2012; No. 61/675,112, titled “Physical-Layer Device Configurable for Implementing Time-Division Duplexing and Frequency-Division Duplexing,” filed Jul. 24, 2012; and No. 61/702,195, titled “Rate Adaptation for Implementing Time-Division Duplexing and Frequency-Division Duplexing in the Physical Layer,” filed Sep. 17, 2012, all of which are hereby incorporated by reference in their entirety.

### TECHNICAL FIELD

The present embodiments relate generally to communication systems, and specifically to communication systems that use time-division duplexing or frequency-division duplexing.

### BACKGROUND OF RELATED ART

The Ethernet Passive Optical Networks (EPON) protocol may be extended over coaxial (coax) links in a cable plant. The EPON protocol as implemented over coax links is called EPoC. Implementing an EPoC network or similar network over a coax cable plant presents significant challenges. For example, EPON-compatible systems traditionally achieve full-duplex communications using frequency-division duplexing (FDD), and the EPON media access control (MAC) layer is a full-duplex MAC as defined in the IEEE 802.3av standard. It is desirable that an EPoC physical layer (PHY) be compatible with the full-duplex EPON MAC. However, cable operators may desire to use time-division duplexing (TDD) instead of FDD for communications between a coax line terminal and coax network units. Furthermore, some cable operators may want to use TDD while others may want to use FDD.

### BRIEF DESCRIPTION OF THE DRAWINGS

The present embodiments are illustrated by way of example and are not intended to be limited by the figures of the accompanying drawings.

FIG. 1A is a block diagram of a coax network in accordance with some embodiments.

FIG. 1B is a block diagram of a network that includes both optical links and coax links in accordance with some embodiments.

FIG. 2 illustrates timing of time-division duplexed upstream and downstream transmissions as measured at a coax line terminal in accordance with some embodiments.

FIG. 3 is a block diagram of a system in which a mode-configurable coax line terminal is coupled to a mode-configurable coax network unit by a coax link in accordance with some embodiments.

FIG. 4 provides a high-level illustration of data transmission in a system in which a TDD scheme is implemented at the PHY level in accordance with some embodiments.

FIG. 5A is a block diagram of sublayers in a PHY configured for TDD and coupled to a full-duplex MAC in accordance with some embodiments.

FIG. 5B shows downstream signals provided between the various sublayers of FIG. 5A in accordance with some embodiments.

FIG. 6A is a block diagram of sublayers in a PHY configured for TDD and coupled to a full-duplex MAC in accordance with some embodiments.

FIG. 6B shows upstream signals provided between the various sublayers of FIG. 6A in accordance with some embodiments.

FIG. 7 illustrates the operation of an OFDM PHY that implements TDD in accordance with some embodiments.

FIG. 8 is a block diagram of a system in which a CLT with a full-duplex MAC and coax PHY configured for TDD is coupled to a CNU with a full-duplex MAC and coax PHY configured for TDD in accordance with some embodiments.

FIG. 9 illustrates downstream transmissions in the system of FIG. 8 in accordance with some embodiments.

FIG. 10A is a block diagram of sublayers in a PHY configured for FDD operation and coupled to a full-duplex MAC in accordance with some embodiments.

FIG. 10B shows outbound signals provided between the various sublayers of FIG. 10A in accordance with some embodiments.

FIG. 11A is a block diagram of sublayers in a PHY coupled to a full-duplex MAC in accordance with some embodiments.

FIG. 11B shows signals provided between the various sublayers of FIG. 11A when transmitting data in an FDD mode in accordance with some embodiments.

FIG. 12A is a block diagram of sublayers in a PHY coupled to a full-duplex MAC in accordance with some embodiments.

FIG. 12B shows signals provided between the various sublayers of FIG. 12A when transmitting data in a TDD mode in accordance with some embodiments.

FIG. 13A is a block diagram of sublayers in a PHY coupled to a full-duplex MAC in accordance with some embodiments.

FIG. 13B shows signals provided between the various sublayers of FIG. 13A when transmitting data in a TDD mode in accordance with some embodiments.

FIG. 14A is a block diagram of sublayers in a PHY coupled to a full-duplex MAC in accordance with some embodiments.

FIG. 14B shows signals provided between the various sublayers of FIG. 14A when receiving data in a TDD mode in accordance with some embodiments.

FIG. 15 is a flowchart showing a method of data communications in accordance with some embodiments.

Like reference numerals refer to corresponding parts throughout the drawings and specification.

### DETAILED DESCRIPTION

In some embodiments, a physical-layer device includes a first sublayer to receive a first continuous bitstream from a media-independent interface and to provide a second continuous bitstream to the media-independent interface. The physical-layer device also includes a second sublayer to transmit first signals corresponding to the first continuous bitstream and to receive second signals corresponding to the second continuous bitstream. The second sublayer is to transmit the first signals and receive the second signals using time-division duplexing in a first mode of operation and using frequency-division duplexing in a second mode of operation.

In some embodiments, a method of data communications is performed in a physical-layer device. A selection is made between a first mode of operation and a second mode of operation. A first continuous bitstream is received from a media-independent interface and a second continuous bitstream is provided to the media-independent interface. When the first mode is selected, time-division duplexing is used to transmit first signals corresponding to the first continuous bitstream and receive second signals corresponding to the second continuous bitstream. When the second mode is selected, frequency-division duplexing is used to transmit the first signals and receive the second signals.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

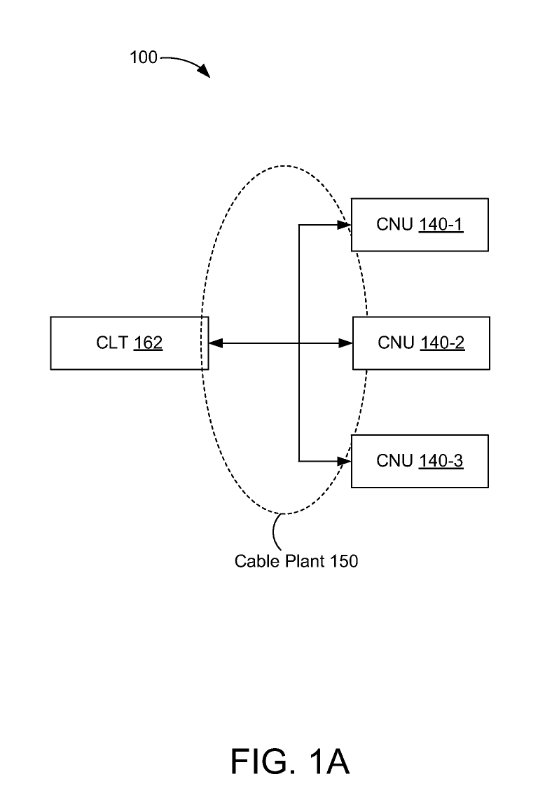

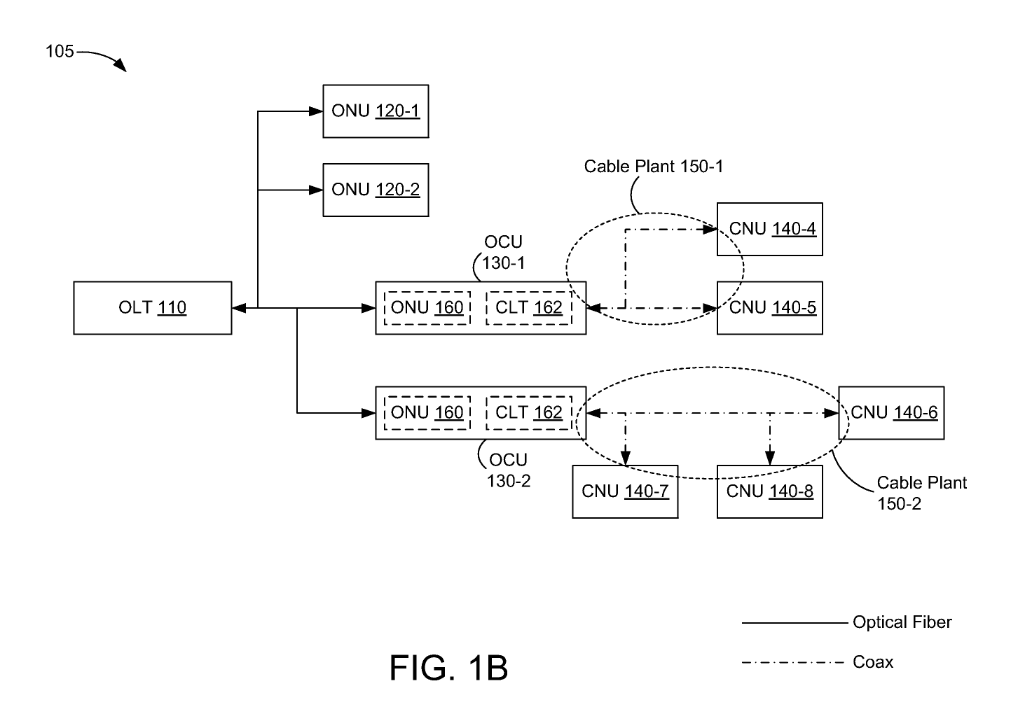

FIG. 1A is a block diagram of a coax network 100 (e.g., an EPoC network) in accordance with some embodiments. The network 100 includes a coax line terminal (CLT) 162 (also referred to as a coax link terminal) coupled to a plurality of coax network units (CNUs) 140-1, 140-2, and 140-3 via coax links. A respective coax link may be a passive coax cable, or may also include one or more amplifiers and/or equalizers. The coax links compose a cable plant 150. In some embodiments, the CLT 162 is located at the headend of the cable plant 150 or within the cable plant 150 and the CNUs 140-1, 140-2, and 140-3 are located at the premises of respective users.

The CLT 162 transmits downstream signals to the CNUs 140-1, 140-2, and 140-3 and receives upstream signals from the CNUs 140-1, 140-2, and 140-3. In some embodiments, each of the CNUs 140-1, 140-2, and 140-3 receives every packet transmitted by the CLT 110 and discards packets that are not addressed to it. The CNUs 140-1, 140-2, and 140-3 transmit upstream signals at scheduled times specified by the CLT 162. For example, the CLT 162 transmits control messages (e.g., GATE messages) to the CNUs 140-1, 140-2, and 140-3 specifying respective future times at which respective CNUs 140-1, 140-2, and 140-3 may transmit upstream signals.

In some embodiments, the CLT 162 is part of an optical-coax unit (OCU) 130-1 or 130-2 that is also coupled to an optical line terminal (OLT) 110, as shown in FIG. 1B. FIG. 1B is a block diagram of a network 105 that includes both optical links and coax links in accordance with some embodiments. In the network 105, the OLT 110 (also referred to as an optical link terminal) is coupled to a plurality of optical network units (ONUs) 120-1 and 120-2 via respective optical fiber links. The OLT 110 also is coupled to a plurality of OCUs 130-1 and 130-2 via respective optical fiber links. OCUs are sometimes also referred to as fiber-coax units (FCUs), media converters, or coax media converters (CMCs).

Each OCU 130-1 and 130-2 includes an ONU 160 coupled with a CLT 162. The ONU 160 receives downstream packet transmissions from the OLT 110 and provides them to the CLT 162, which forwards the packets to the CNUs 140 (e.g., CNUs 140-4 and 140-5, or CNUs 140-6, 140-7, and 140-8) on its cable plant 150 (e.g., cable plant 150-1 or 150-2). In some embodiments, the CLT 162 filters out packets that are not addressed to CNUs 140 on its cable plant 150 and forwards the remaining packets to the CNUs 140 on its cable plant 150. The CLT 162 also receives upstream packet transmissions from CNUs 140 on its cable plant 150 and provides these to the ONU 160, which transmits them to the OLT 110. The ONUs 160 thus receive optical signals from and transmit optical signals to the OLT 110, and the CLTs 162 receive electrical signals from and transmit electrical signals to CNUs 140.

In the example of FIG. 1 B, the first OCU 130-1 communicates with CNUs 140-4 and 140-5, and the second OCU 130-2 communicates with CNUs 140-6, 140-7, and 140-8. The coax links coupling the first OCU 130-1 with CNUs 140-4 and 140-5 compose a first cable plant 150-1. The coax links coupling the second OCU 130-2 with CNUs 140-6 through 140-8 compose a second cable plant 150-2. A respective coax link may be a passive coax cable, or alternately may include one or more amplifiers and/or equalizers. In some embodiments, the OLT 110, ONUs 120-1 and 120-2, and optical portions of the OCUs 130-1 and 130-2 (e.g., including the ONUs 160) are implemented in accordance with the Ethernet Passive Optical Network (EPON) protocol.

In some embodiments, the OLT 110 is located at a network operator's headend, the ONUs 120-1 and 120-2 and CNUs 140-4 through 140-8 are located at the premises of respective users, and the OCUs 130-1 and 130-2 are located at the headend of their respective cable plants 150-1 and 150-2 or within their respective cable plants 150-1 and 150-2.

In some embodiments, communications on a respective cable plant 150 are performed using time-division duplexing (TDD): the same frequency band is used for both upstream transmissions from the CNUs 140 to the CLT 162 and downstream transmissions from the CLT 162 to the CNUs 140, and the upstream and downstream transmissions are duplexed in time. For example, alternating time windows are allocated for upstream and downstream transmissions. A time window in which a packet is transmitted from a CNU 140 to a CLT 162 is called an upstream time window or upstream window, while a time window in which a packet is transmitted from a CLT 162 to a CNU 140 is called a downstream time window or downstream window.

Alternatively, communications on a respective cable plant 150 are performed using frequency-division duplexing (FDD): different frequency bands are used for upstream and downstream transmissions. In some embodiments, the CLT 162 and/or the CNUs 140 are configurable to perform TDD in a first mode and FDD in a second mode.

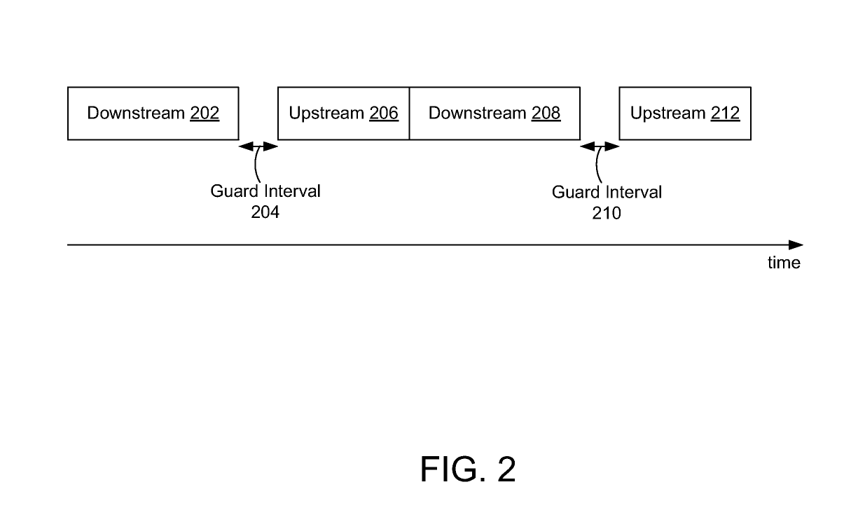

FIG. 2 illustrates timing of upstream and downstream time windows as measured at a CLT 162 (FIGS. 1 A and 1 B) in accordance with some embodiments. As shown in FIG. 2, alternating windows are allocated for upstream and downstream transmissions. During a downstream time window 202, the CLT 162 transmits signals downstream to CNUs 140. The downstream time window 202 is followed by a guard interval 204, after which the CLT 162 receives upstream signals from one or more of the CNUs 140 during an upstream time window 206. The guard interval 204 accounts for propagation time on the coaxial links and for switching time in the CLT 162 to switch from a transmit configuration to a receive configuration. The guard interval 204 thus ensures separate upstream and downstream time windows at the CNUs 140. The upstream time window 206 is immediately followed by another downstream time window 208, another guard interval 210, and another upstream time window 212. Alternating downstream and upstream time windows continue in this manner, with successive downstream and upstream time windows being separated by guard intervals and the downstream time windows immediately following the upstream time windows, as shown in FIG. 2. The upstream and downstream transmissions during the time windows 202, 206, 208, and 212 use the same frequency band. The time allocated for upstream time windows (e.g., windows 206 and 212) may be different than the time allocated for downstream time windows (e.g., windows 202 and 208). FIG. 2 illustrates an example in which more time (and thus more bandwidth) is allocated to downstream time windows 202 and 208 than to upstream time windows 206 and 212.

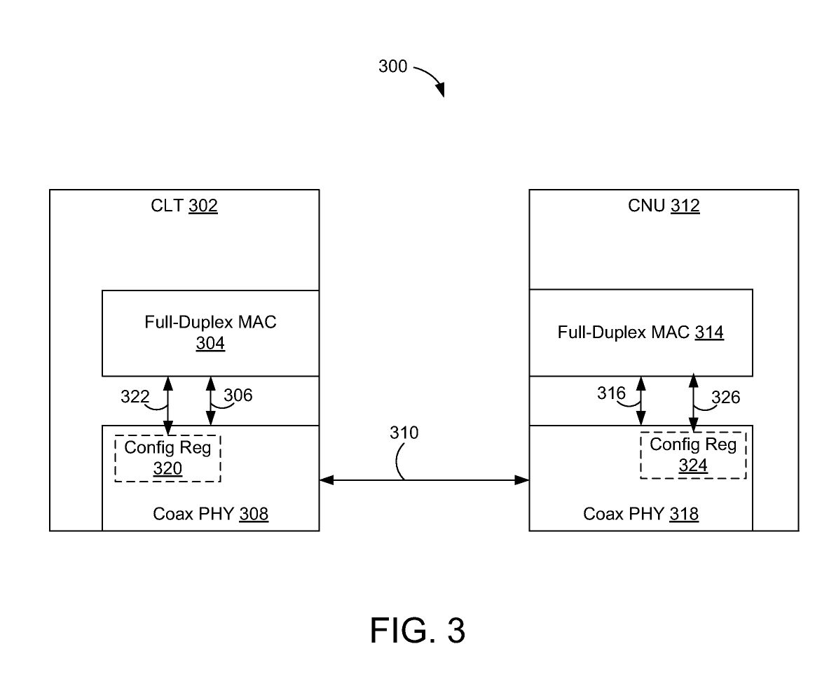

FIG. 3 is a block diagram of a system 300 configurable to use TDD (e.g., in accordance with FIG. 2) in a first mode and FDD in a second mode in accordance with some embodiments. The system 300 includes a CLT 302 coupled to a CNU 312 by a coax link 310. The CLT 302 is an example of a CLT 162 (FIGS. 1A-1 B) and the CNU 312 is an example of one of the CNUs 140-1 through 140-8 (FIGS. 1A-1B). The CLT 302 and CNU 312 communicate via the coax link 310 using TDD in the first mode and FDD in the second mode.

The CLT 302 includes a coax PHY 308 coupled to a full-duplex MAC 304 by a media-independent interface 306. The media-independent interface 306 continuously conveys signals from the full-duplex MAC 304 to the coax PHY 308 and also continuously conveys signals from the coax PHY 308 to the full-duplex MAC 304. Similarly, the CNU 312 includes a coax PHY 318 coupled to a full-duplex MAC 314 by a media-independent interface 316. The media-independent interface 316 continuously conveys signals from the full-duplex MAC 314 to the coax PHY 318 and also continuously conveys signals from the coax PHY 318 to the full-duplex MAC 314. The coax link 310 couples the coax PHY 308 to the coax PHY 318.

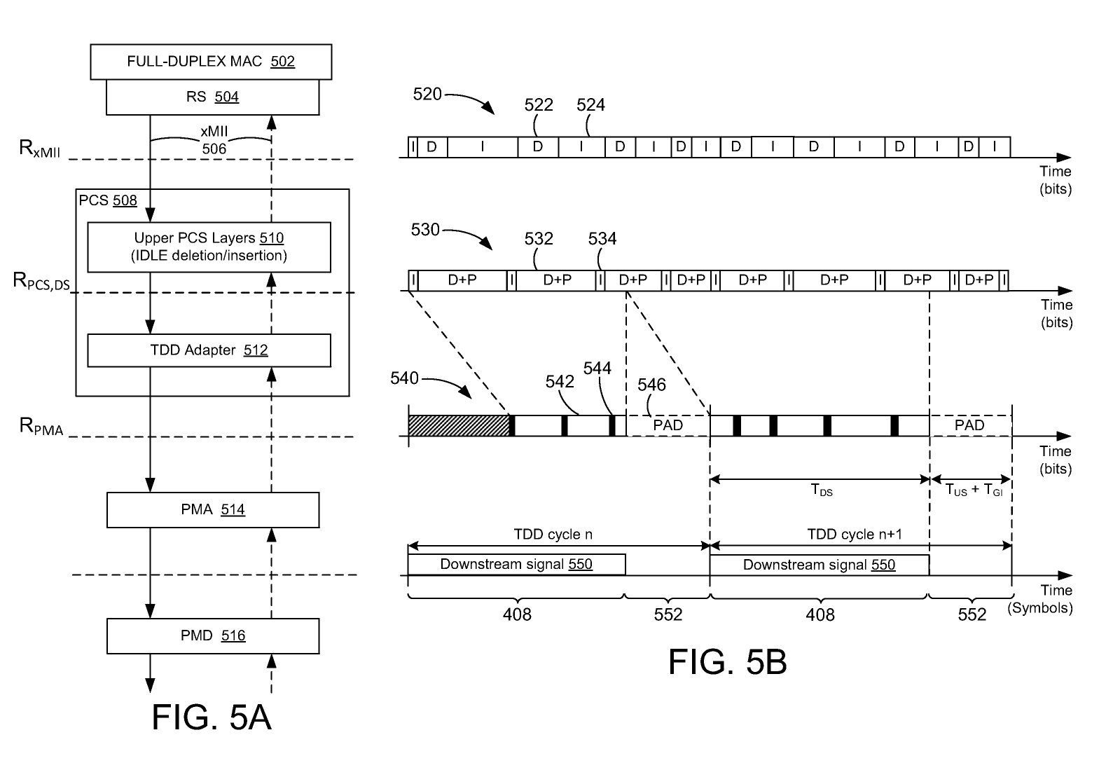

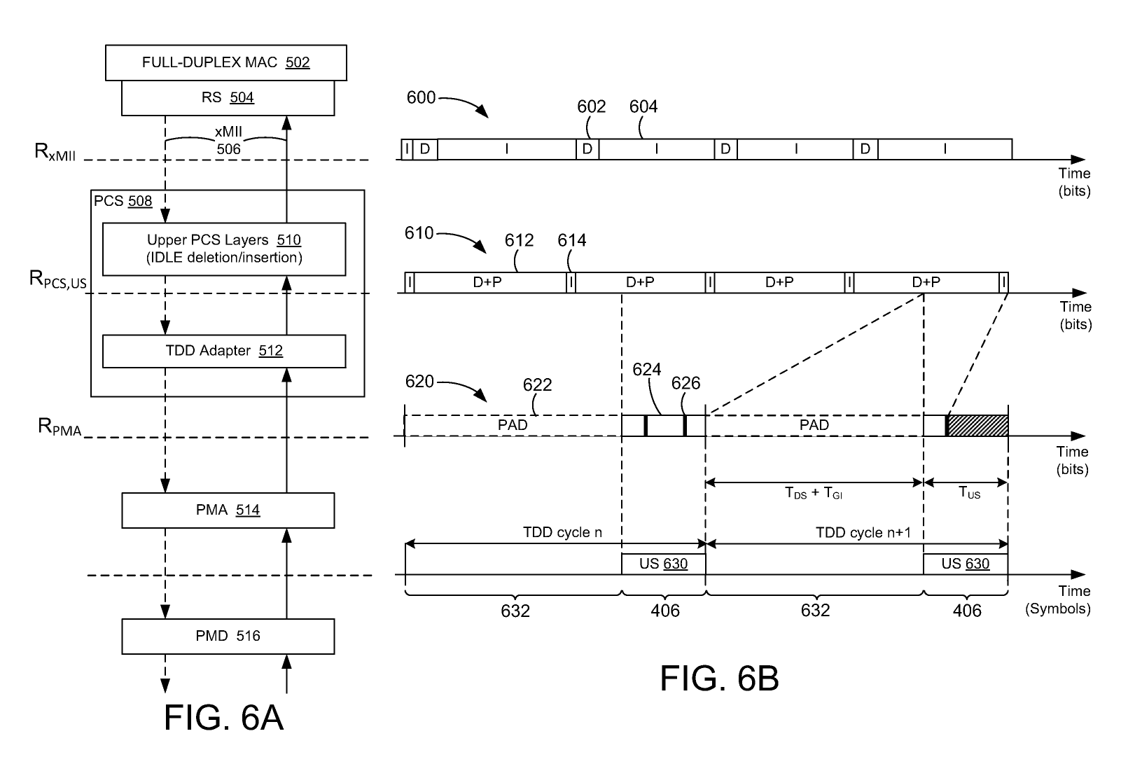

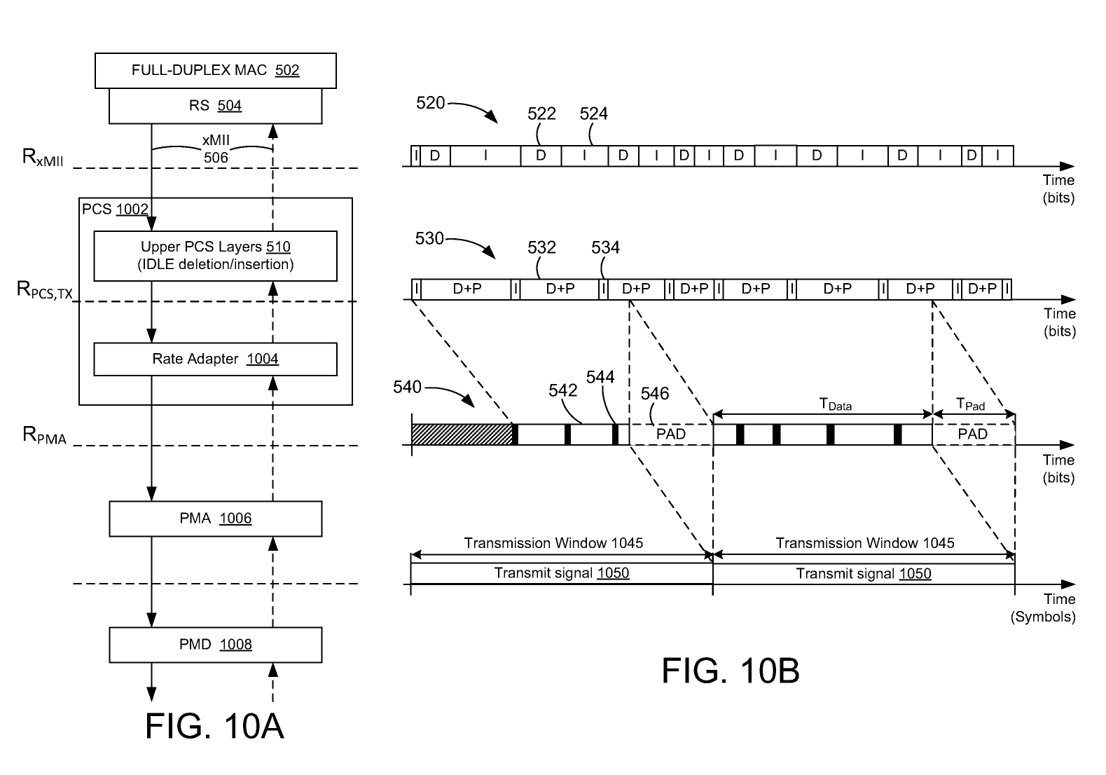

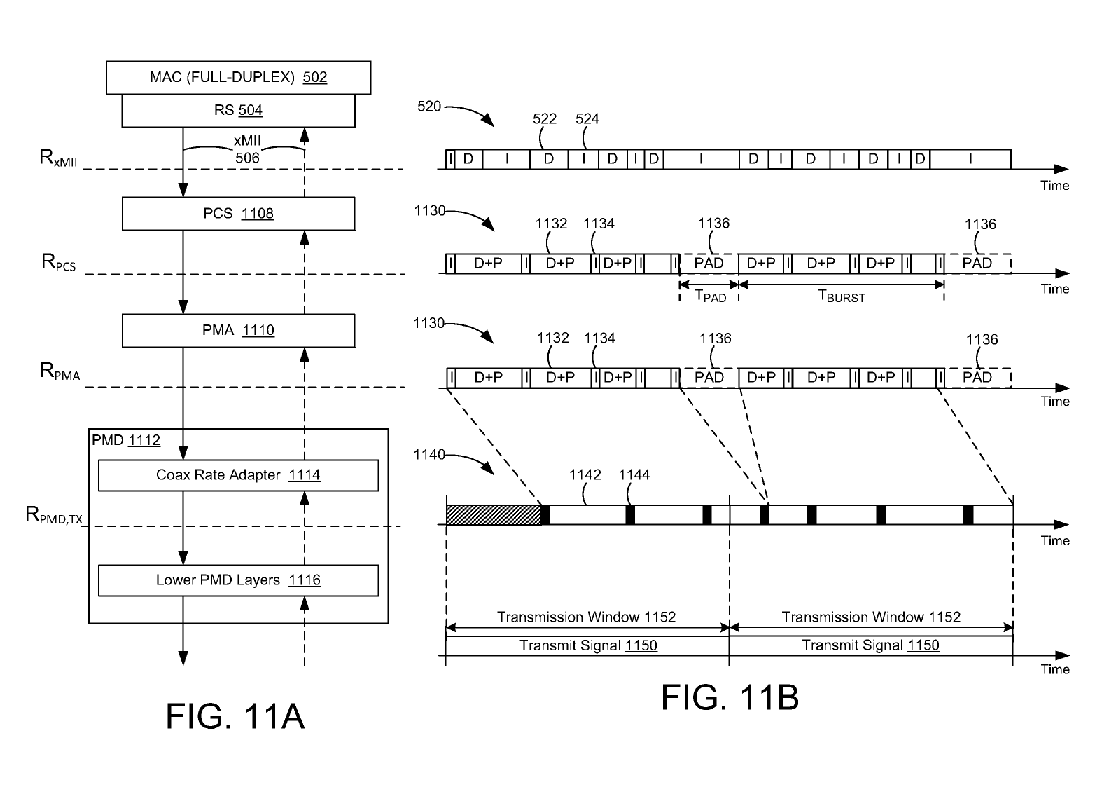

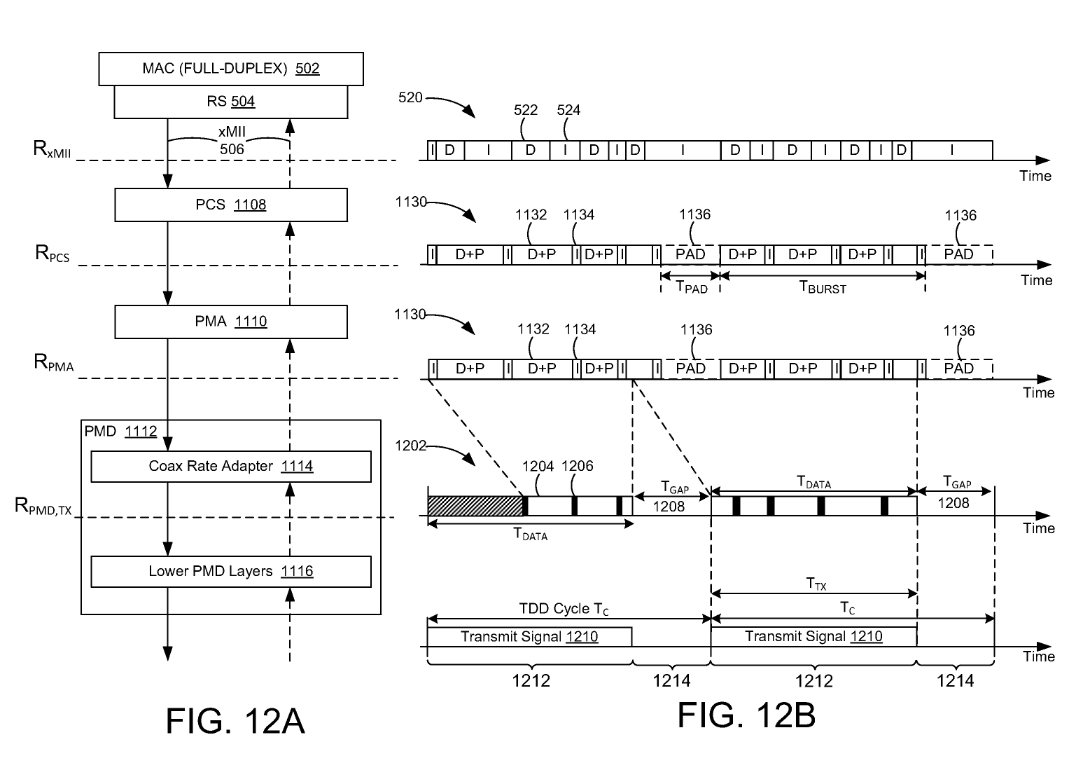

The data rate of the media-independent interfaces 306 and 316 in each direction is higher than the data rate for the coax link 310, allowing the coax PHYs 308 and 318 to perform TDD communications in the first mode despite being respectively coupled to the full-duplex MACs 304 and 314. TDD functionality for the CLT 302 and CNU 312 is thus achieved entirely in the coax PHYs 308 and 318 in the first mode in accordance with some embodiments. In some embodiments, the coax PHYs 308 and 318 are configurable to operate as described below with respect to FIGS. 5A-5B and 6A-6B in the first mode and with respect to FIGS. 10A-10B in the second mode. In some other embodiments, the coax PHYs 308 and 318 are configurable to operate as describe below with respect to FIGS. 12A-12B, 13A-13B, and 14A-14B in the first mode and with respect to FIGS. 11A-11B in the second mode. The coax PHYs 308 and 318 may be configured by storing appropriate values (e.g., a first value corresponding to the first mode or a second value corresponding to the second mode) in their respective configuration registers 320 and 324. The configuration registers 320 and 324 are programmed, for example, using respective management data input/output (MDIO) buses 322 and 326 in the CLT 302 and CNU 312.

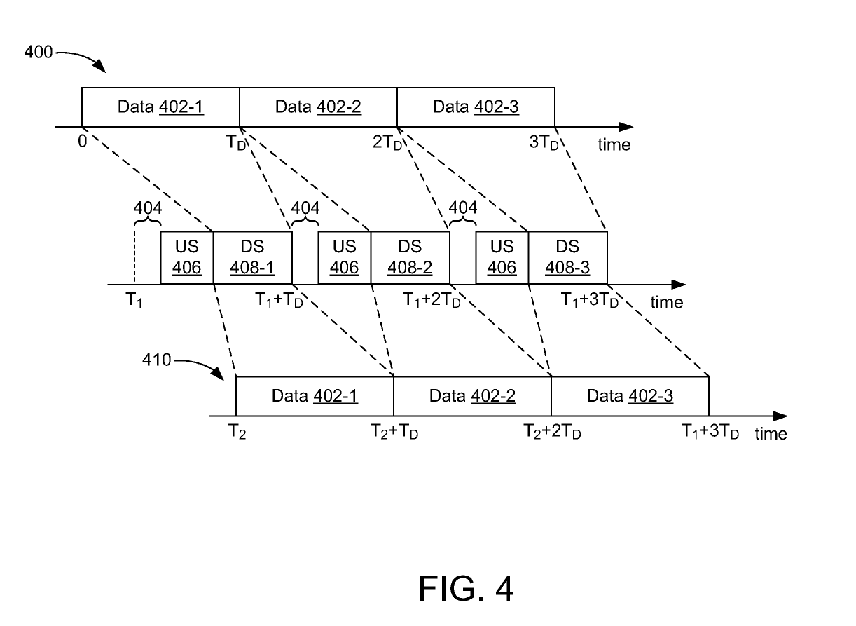

FIG. 4 provides a high-level illustration of downstream data transmission in the system 300 (FIG. 3) in the first mode in accordance with some embodiments. The data transmission uses a TDD scheme implemented at the PHY level. A continuous bitstream 400 is provided from the full-duplex MAC 304 to the coax PHY 308. The bitstream 400 includes data 402-1 provided during a TDD period from times 0 to T_{D}, data 402-2 provided during a TDD period from times T_{D} to 2T_{D}, and data 402-3 provided during a TDD period from times 2T_{D} to 3T_{D}. A TDD period is the total period of time associated with a guard interval 404, an upstream window 406, and a downstream window 408-1, 408-2, or 408-3 in sequence. The duration of each TDD period equals T_{D}, as shown in FIG. 4. The guard intervals 404 are examples of guard intervals 204 or 210 (FIG. 2). The upstream windows 406 are examples of upstream time windows 206 or 212 (FIG. 2). The downstream windows 408-1, 408-2, and 408-3 are examples of downstream time windows 202 and 208 (FIG. 2).

The coax PHY 308 (FIG. 3) converts the data 402-1 into a first downstream transmission signal that is transmitted during a first downstream (DS) window 408-1. Likewise, the data 402-2 is converted into a second downstream transmission signal that is transmitted during a second downstream window 408-2, and the data 402-3 is converted into a third downstream transmission signal that is transmitted during a third downstream window 408-3. In this example, T₁ represents the processing time for the coax PHY 308 to perform this conversion. Each downstream window 408-1, 408-2, and 408-3 is included in a respective TDD period that also includes an upstream (US) window 406 and a guard interval 404. The coax PHY 318 (FIG. 3) in the CNU 312 receives the downstream transmission signals and reconstructs a continuous bitstream 410 that includes the data 402-1, 402-2, and 402-3. Starting at a time T₂, the coax PHY 318 passes the continuous bitstream to the full-duplex MAC 314 (FIG. 3). In this example, T₂ represents the channel delay on the coax link 310 plus processing time in both the coax PHY 308 and coax PHY 318.

While FIG. 4 illustrates downstream transmission, a similar scheme may be used for upstream transmission in the first mode. For example, the full-duplex MAC 314 in the CNU 312 (FIG. 3) may provide a continuous bitstream to the coax PHY 318, which converts the data in the bitstream into discrete transmission signals that are transmitted upstream during successive upstream transmission windows 406 (assuming the successive upstream windows 406 are allocated to the CNU 312 and not to other CNUs on the cable plant). The coax PHY 308 in the CLT 302 (FIG. 3) receives the transmission signals, reconstructs the continuous bitstream, and provides the reconstructed bitstream to the full-duplex MAC 304.

To convert the continuous bitstream 400 into the discrete signals transmitted during the transmission windows 408-1, 408-2, and 408-3, the coax PHY 308 performs symbol mapping and maps the symbols to corresponding time slots and physical resources in the transmission windows 408-1, 408-2, and 408-3. A single carrier or multi-carrier transmission scheme may be used.

A more detailed example of TDD operation for downstream transmissions is now provided with reference to FIGS. 5A and 5B. (More generally, FIGS. 5A and 5B illustrate outbound signals in a PHY. A downstream signal is outbound in a CLT 162, while an upstream signal is outbound in a CNU 140.) In FIG. 5A, a PHY (e.g., coax PHY 308, FIG. 3) includes a physical coding sublayer (PCS) 508, a physical medium attachment sublayer (PMA) 514, and a physical medium dependent sublayer (PMD) 516. The PCS 508 is coupled to a full-duplex MAC 502 (e.g., MAC 304, FIG. 3) through a media independent interface (xMII) 506 and a reconciliation sublayer (RS) 504. In some embodiments, the media-independent interface 506 is a 10 Gigabit Media-Independent Interface (XGMII) operating at 10 Gbps. (The term media-independent interface may refer to a family of interfaces but also to a particular type of media-independent interface in the family. As used herein, the term refers to the family of interfaces and is abbreviated xMII to distinguish it from specific media-independent interfaces such as XGMII.) The media-independent interface 506 is shown symbolically in FIG. 5A as arrows but in practice includes first interface circuitry coupled to the RS 504, second interface circuitry coupled to the PCS 508 in the PHY, and one or more signal lines connecting the first and second interface circuitry.

In some embodiments, the PHY of FIG. 5A, including the PCS 508, PMA 514, PMD 516, and the PHY's portion of xMII 506, is implemented in hardware in a single integrated circuit. The full-duplex MAC 502 may be implemented in a separate integrated circuit or the same integrated circuit.

FIG. 5B is aligned with FIG. 5A to show downstream signals (or, more generally, outbound signals) provided between the various sublayers of FIG. 5A in accordance with some embodiments. The signals of FIG. 5B thus correspond to the solid downward arrows of FIG. 5A. The full-duplex MAC 502 transmits a continuous bitstream 520 across the media-independent interface 506 to the PCS 508. The media-independent interface 506 runs at a fixed rate R_{xMII} that is higher than the rates of other interfaces in the system of FIG. 5A. The bitstream 520 includes data packets 522 (in corresponding frames) and idle packets 524 (in corresponding frames); the idle packets 524 are included in the bitstream 520 to maintain the fixed rate R_{xMII} of the media-independent interface 506.

The PCS 508 includes one or more upper PCS layers 510 that remove the idle packets 524 and perform a forward error correction (FEC) encoding process that inserts parity bits in the data packets (D+P), resulting in a bitstream 530 that includes data packets 532 and idle characters 534 that act as packet separators. The one or more upper PCS layers 510 provide the bitstream 530 to a TDD adapter 512 in the PCS 508 at a downstream baud rate of R_{PCS,DS}. The TDD adapter 512 adapts the bitstream 530 to a higher baud rate R_{PMA} and inserts pad bits 546, resulting in a bitstream 540 that is provided to the PMA 514 at R_{PMA}. The bitstream 540 includes data packets 542 and idle characters 544 that correspond respectively to the data packets 532 and idle characters 534 of the bitstream 530. The pad bits 546 correspond to time slots 552 during which the PMA 514 and PMD 516 cannot transmit downstream. The time slots 552 correspond, for example, to guard intervals 404 and upstream windows 406 (FIG. 4).

The PMA 514 (or alternatively, the PMD 516) converts the packets 542 into downstream signals 550 that the PMD 516 transmits during downstream windows 408 (e.g., windows 408-1, 408-2, and 408-3, FIG. 4). Each downstream window 408 (FIG. 4) has a duration T_{DS} and each time slot 552 has a duration T_{US}+T_{GI}, where T_{US} is the duration of an upstream window 406 and T_{GI} is the duration of a guard interval 404.

The baud rates R_{PCS,DS} and R_{PMA} are related as follows:

$${R}_{PCS , DS} = {R}_{PMS} \times \frac{{T}_{DS}}{{T}_{DS} + {T}_{US} + {T}_{GI}} . \qquad ( 1 )$$

Equation (1) shows that R_{PCS,DS} is a fraction of R_{PMA} as determined by the ratio of T_{DS} to an entire TDD cycle. (In FIG. 5B, the indices n and n+1 are used to index successive TDD cycles.)

An example of TDD operation for upstream transmissions is now provided with reference to FIGS. 6A and 6B. (More generally, FIGS. 6A and 6B illustrate inbound signals in a PHY. A downstream signal is inbound in a CNU 140, while an upstream signal is inbound in a CLT 162.) The PHY and full-duplex MAC 502 and of FIG. 6A are the same PHY and full-duplex MAC 502 in FIG. 5A. FIG. 6B is aligned with FIG. 6A to show upstream (or, more generally, inbound) signals provided between the various sublayers of FIG. 6A. The signals of FIG. 6B thus correspond to the solid upward arrows of FIG. 6A. The PMD 516 receives analog upstream signals during upstream windows 406 (FIG. 4) and converts them to digital upstream (US) signals 630, which are provided to the PMA 514. No upstream signals 630 are present during time slots 632, each of which includes a downstream window 408 and a guard interval 404 (FIG. 4).

The PMA 514 inserts pad bits 622 during the time slots 632, resulting in a bitstream 620 that also includes data packets 624 in corresponding frames and idle characters 626 that separate the data packets 624. The data packets 624 include parity bits. The PMA 514 provides the bitstream 620 to the TDD adapter 512 at the baud rate R_{PMA}, which is the same R_{PMA} as for downstream communications. The TDD adapter 512 discards the pad bits 622 and adapts the bitstream 620 to a baud rate R_{PCS,US}, resulting in the bitstream 610. The bitstream 610 includes data packets 612 and idle characters 614 that correspond to the data packets 624 and idle characters 626 as adapted to R_{PCS,US}. R_{PCS,US} is defined as:

$${R}_{PCS , US} = {R}_{PMA} \times \frac{{T}_{US}}{{T}_{DS} + {T}_{US} + {T}_{GI}} . \qquad ( 2 )$$

Equation (2) shows that R_{PCS,US} is a fraction of R_{PMA} as determined by the ratio of T_{US} to an entire TDD cycle. In general, R_{PCS,US} is not equal to R_{PCS,DS}, although they will be equal if T_{DS} equals T_{US}.

The TDD adapter 512 provides the bitstream 610 to the one or more upper PCS layers 510, which discard the parity bits, fill the resulting empty spaces, and adapt the bitstream 610 to R_{xMII} by inserting idle packets 604, resulting in the bitstream 600. The data packets 602 of the bitstream 600 correspond to the data packets 612 with the parity bits removed, as adapted to R_{xMII}. In some embodiments, R_{xMII} is the same in the upstream and downstream directions. The upper PCS layers 510 provide the bitstream 600 at R_{xMII} to the full-duplex MAC 502 via the media-independent interface 506 and RS 504. The combination of FIGS. 5B and 6B illustrate the full-duplex nature of the MAC 502: it simultaneously transmits the continuous downstream bitstream 520 (FIG. 5B) and receives the continuous upstream bitstream 600 (FIG. 6B).

FIGS. 5A-5B and 6A-6B thus illustrate how to implement TDD functionality in the PCS sublayer 508 by adding a TDD adapter 512 to the PCS sublayer 508. As described, the TDD adapter 512 performs rate adaptation to ensure that the amount of data in the bitstreams 520 and 530 (or 600 and 610) during a TDD cycle equals the amount of data in the bitstream 540 (or 620) during a downstream (or upstream) window. In some embodiments, the other sublayers of the PHY of FIGS. 5A and 6A (e.g., the one or more upper PCS layers 510, PMA 514, and PMD 516) function as defined in the IEEE 802.3 family of standards.

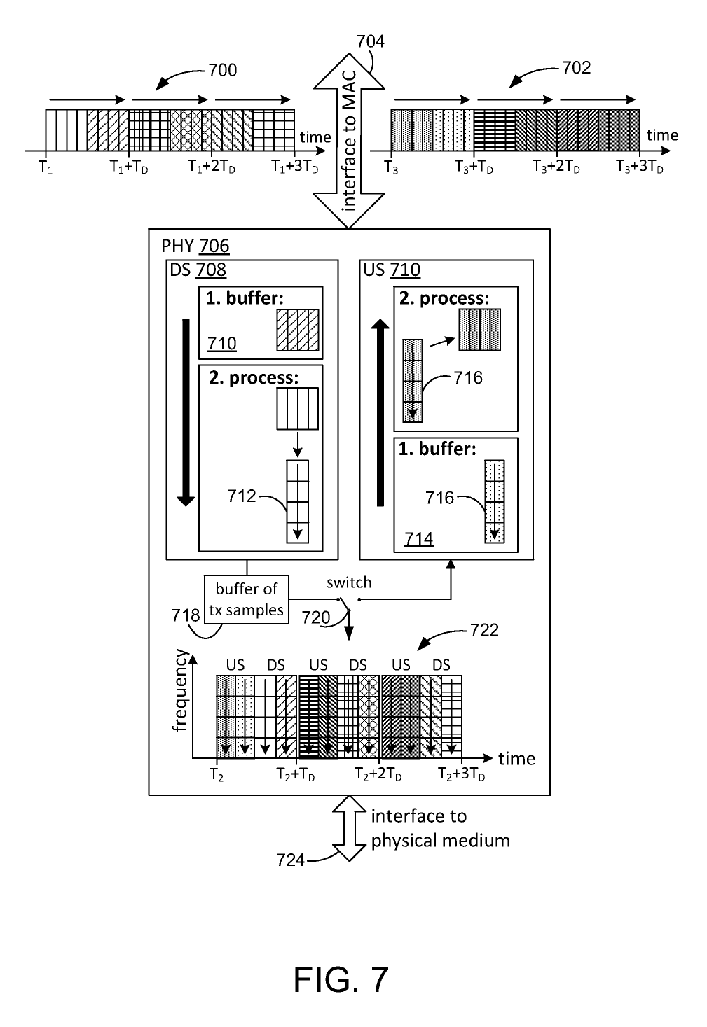

In some embodiments, the PHY of FIGS. 5A and 6A (e.g., each of the coax PHYs 308 and 318, FIG. 3) are orthogonal frequency-division multiplexing (OFDM) PHYs that transmit and receive OFDM symbols using TDD in the first mode. FIG. 7 illustrates the TDD operation of such an OFDM PHY 706 in accordance with some embodiments. The PHY 706 is coupled to a full-duplex MAC (e.g., MAC 502, FIGS. 5A and 6A; MAC 304, FIG. 3) by a media-independent interface 704 (e.g., xMII 506, FIGS. 5A and 6A; interface 306, FIG. 3). In the downstream direction, the MAC provides a continuous bitstream 700 to the PHY 706. Downstream processing circuitry 708 (including, for example, downstream portions of the PCS 508, PMA 514, and PMD 516, FIG. 5A) collects data from the bitstream 700 in a buffer 710. Once enough data has been collected for processing (e.g., for encoding/OFDM symbol construction), the data are converted to time-domain samples 712 to be transmitted in OFDM symbols. The samples 712 are buffered in a buffer 718 until a switch 720 is set to couple the buffer 718 to a physical medium interface 724 (also referred to as a medium-dependent interface), thus beginning a downstream transmission window. In the example of FIG. 7, two downstream OFDM symbols 722 are transmitted during the downstream (DS) window of each TDD cycle. (In FIG. 7, data in the bitstreams 700 and 702 have the same fill patterns as their corresponding OFDM symbols 722.)

During upstream windows, the switch 720 is set to couple the interface 724 to a buffer 714 in upstream processing circuitry 710. The upstream processing circuitry 710 includes, for example, upstream portions of the PCS 508, PMA 514, and PMD 516 (FIG. 6A). The buffer 714 buffers time-domain samples 716 in received OFDM symbols. In the example of FIG. 7, two upstream OFDM symbols 722 are received during the upstream (US) window of each TDD cycle. Once the buffer 714 collects enough samples 716 for processing (e.g., FFT processing, demodulation, or decoding), the upstream processing circuitry 710 converts the samples 716 into bitstream data, thereby recovering a continuous bitstream 702 that is provided to the full-duplex MAC via the media-independent interface 704.

While FIG. 7 shows downstream transmission and upstream reception, downstream reception and upstream transmission may be performed in a similar manner (e.g., in a CNU 312, FIG. 3).

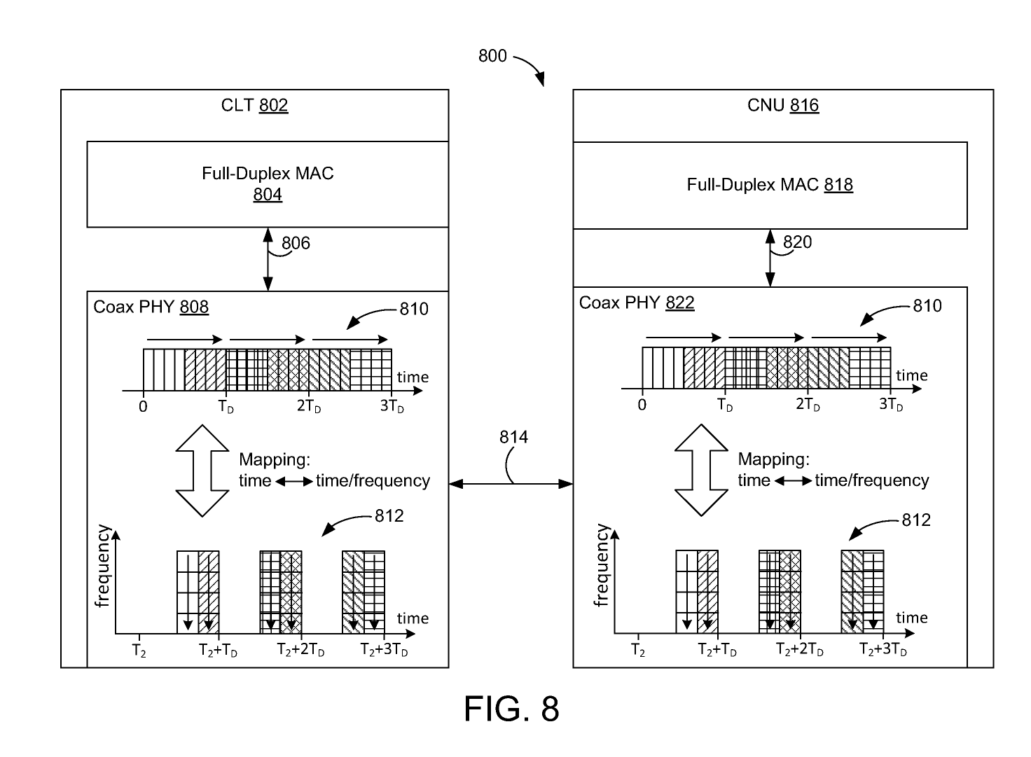

FIG. 8 is a block diagram of a system 800 in which a CLT 802 with a full-duplex MAC 804 and coax TDD PHY 808 is coupled to a CNU 816 with a full-duplex MAC 818 and coax TDD PHY 822 in accordance with some embodiments. The system 800 is an example of the system 300 (FIG. 3). A coax link 814 couples the PHYs 808 and 822. A media-independent interface 806 couples the MAC 804 with the PHY 808 in the CLT 802, and a media-independent interface 820 couples the MAC 818 with the PHY 822 in the CNU 816. In the downstream direction, the PHY 808 performs mapping to convert data in a continuous bitstream 810 to OFDM symbols 812 that are transmitted to the PHY 822 during downstream windows, and the PHY 822 performs mapping to recover data from the received OFDM symbols 812 and recreate the continuous bitstream 810. In the upstream direction, the PHY 822 performs mapping to convert data in a continuous bitstream 810 to OFDM symbols 812 that are transmitted to the PHY 808 during upstream windows, and the PHY 808 performs mapping to recover the data from the received OFDM symbols 812 and recreate the continuous bitstream 810. (While FIG. 8 shows a single bitstream 810 for simplicity, in practice there are separate upstream and downstream bitstreams that are continuously sent in both respective directions between the MAC 804 and PHY 808 in the CLT 802, and also between the MAC 818 and PHY 822 in the CNU 816.)

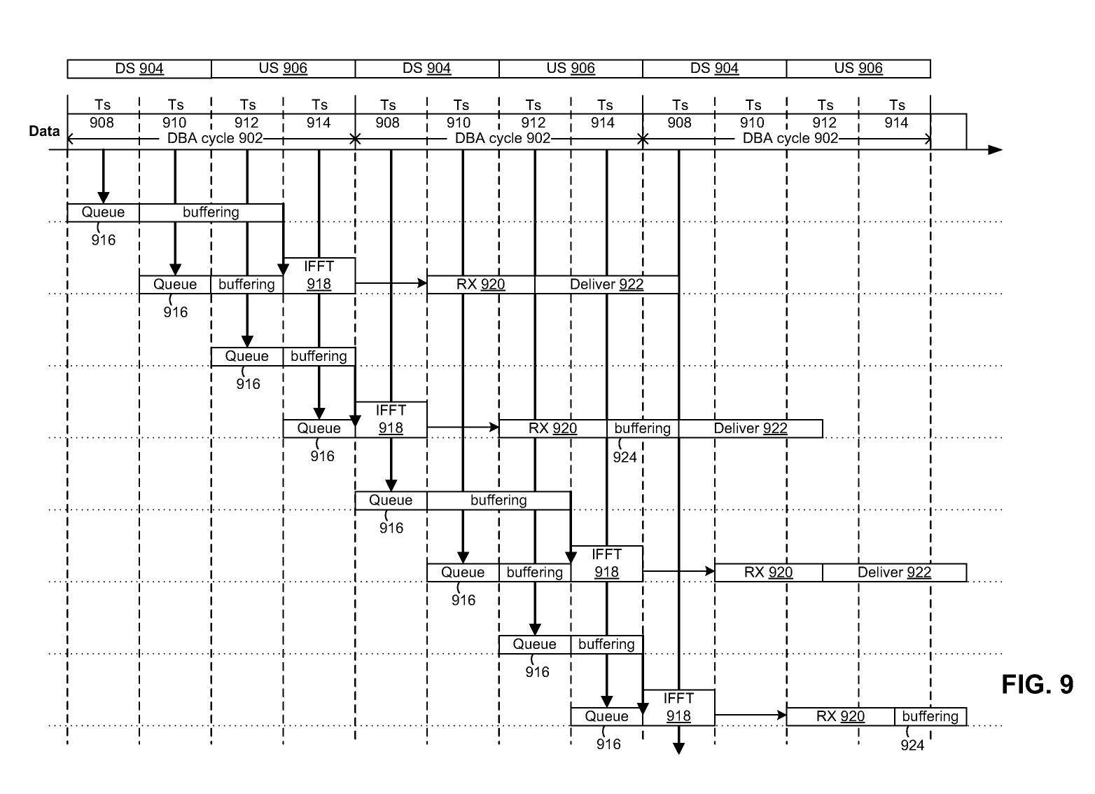

FIG. 9 further illustrates downstream transmissions in the system 800 (FIG. 8) in accordance with some embodiments. The PHY 808 of the CLT 802 receives a continuous bitstream of data from the full-duplex MAC 804 (FIG. 8) during a series of DBA cycles 902. (DBA stands for dynamic bandwidth allocation; a DBA cycle 902 is another term for a TDD cycle. Each DBA cycle 902 includes a downstream window 904 and an upstream window 906, as well as a guard interval, which is not shown in FIG. 9 for simplicity.) Each DBA cycle 902 is divided into four periods 908, 910, 912, and 914 (or, more generally, a plurality of periods) of duration Ts. In the examples of FIGS. 7-9, two OFDM symbols are transmitted downstream during each DBA cycle 902. Therefore, the bitstream data for each period 908, 910, 912, and 914 is data for half an OFDM symbol.

The data for the first and second periods 908 and 910 of the first DBA cycle 902 are provided to a queue 916 (e.g., buffer 710, FIG. 7), where they are buffered. Once all the data for the first and second periods 908 and 910 have been collected, inverse fast Fourier transform (IFFT) processing 918 is performed to convert them to samples from which a first OFDM symbol is constructed. (Other processing, such as channel coding performed in the PCS 508, FIGS. 5A and 6A, is omitted from FIG. 9 for simplicity.) The first OFDM symbol is then transmitted from the PHY 808 of the CLT 802 to the PHY 822 of the CNU 816 during a portion of a downstream window 904 that occurs during the first period 908 of the second DBA cycle 902. The PHY 822 recovers the bitstream data from the first OFDM symbol during receive (RX) processing 920 and delivers 922 the recovered bitstream data to the MAC 818. The duration of this delivery 922 equals the duration of two periods (i.e., 2*Ts), as shown.

The data for the third and fourth periods 912 and 914 of the first DBA cycle 902 are provided to the queue 916, where they are buffered. Once all the data for the third and fourth periods 912 and 914 have been collected, inverse fast Fourier transform (IFFT) processing 918 is performed to convert them to samples from which a second OFDM symbol is constructed. (Again, other processing, such as channel coding performed in the PCS 508, FIGS. 5A and 6A, is omitted from FIG. 9 for simplicity.) The second OFDM symbol is then transmitted from the PHY 808 of the CLT 802 to the PHY 822 of the CNU 816 (FIG. 8) during a portion of the downstream window 904 that occurs during the second period 910 of the second DBA cycle 902. During receive (RX) processing 920, the PHY 822 (FIG. 8) recovers the bitstream data from the second OFDM symbol. The PHY 822 then buffers 924 the recovered bitstream data before delivering 922 the recovered bitstream data to the MAC 818 (FIG. 8). This delivery 922 immediately follows delivery 922 of the data received in the first OFDM symbol.

Downstream transmission continues in this manner, with the result that a continuous recovered bitstream is delivered from the PHY 822 to the MAC 818 of the CNU 816, even though OFDM symbols are only transmitted downstream during a portion of each DBA cycle 902.

While FIG. 9 illustrates downstream transmissions, upstream transmissions may be performed in an analogous manner.

Attention is now directed to the use of a rate adapter in a PHY configured for FDD in accordance with some embodiments. FIG. 10A is a block diagram of sublayers in a PHY configured for FDD operation and coupled to a full-duplex MAC 502 in accordance with some embodiments, and FIG. 10B shows outbound signals provided between the various sublayers of FIG. 10A. The PHY of FIG. 10A includes a physical coding sublayer (PCS) 1002, a physical medium attachment sublayer (PMA) 1006, and a physical medium dependent sublayer (PMD) 1008. The PCS 1002 is coupled to the full-duplex MAC 502 (e.g., MAC 304 and/or 314, FIG. 3) through a media independent interface (xMII) 506 and a reconciliation sublayer (RS) 504, in the same manner as for the PCS 508 (FIGS. 5A and 6A). In some embodiments, the media-independent interface 506 is an XGMII. In some embodiments, the PHY of FIG. 10A, including PCS 1002, PMA 1006, PMD 1008, and the PHY's portion of xMII 506, is implemented in hardware in a single integrated circuit. The full-duplex MAC 502 may be implemented in a separate integrated circuit or the same integrated circuit.

FIG. 10B is aligned with FIG. 10A to show outbound signals provided between the various sublayers of FIG. 10A. (Inbound signals are not shown in FIG. 10B for visual simplicity. A downstream signal is outbound in a CLT 162 and inbound in a CNU 140, while an upstream signal is outbound in a CNU 140 and inbound in a CLT 162.) The full-duplex MAC 502 transmits a continuous bitstream 520 across the media-independent interface 506 to the PCS 1002. The media-independent interface 506 runs at a fixed rate R_{xMII} that is higher than the rates of other interfaces in the system of FIG. 10A. The bitstream 520 includes data packets 522 and idle packets 524; the idle packets 524 are included in the bitstream 520 to maintain the fixed rate R_{xMII}.

The PCS 1002 includes one or more upper PCS layers 510 that function as described for FIG. 5A: they remove the idle packets 524 and perform an FEC encoding process that inserts parity bits in the data packets (D+P), resulting in a transmit bitstream 530 (FIG. 5B) that includes data packets 532 and idle characters 534 that act as packet separators. The upper PCS layers 510 provide the bitstream 530 to a rate adapter 1004 in the PCS 1002 at a baud rate of R_{PCS,TX}. In some embodiments, the PHY of FIG. 10A is an OFDM PHY and the baud rate R_{PCS,TX} is determined as a function of symbol duration, the number of sub-carriers, and modulation order. In one example, the OFDM symbol duration is 100 us, the number of sub-carriers is 12,000, and the maximum modulation order is 1024-QAM, which corresponds to 10 bits. R_{PCS,TX} in this example equals 1.2 Gbps, as calculated by multiplying the number of bits for the maximum modulation order by the number of sub-carriers and dividing by the OFDM symbol duration.

The rate adapter 1004 adapts the bitstream 530 to a higher baud rate R_{PMA} and inserts pad bits 546, resulting in a transmit bitstream 540 (FIG. 5B) that is provided to the PMA 1006 at R_{PMA}. In doing so, the rate adapter 1004 divides the bitstream into time slices of duration T_{Data}. Each time slice of duration T_{Data} corresponds to a transmission window 1045 and is separated from previous and successive time slices by sequences of pad bits 546 of duration T_{Pad}. The pad bits 546 are zero symbols or a specific sequence that the PMA 1006 understands as not corresponding to data for transmission. The bitstream 540 includes data packets 542 and idle characters 544 that correspond respectively to the data packets 532 and idle characters 534 of the bitstream 530.

The PMA 1006 converts the packets 542 within respective time slices T_{Data} into transmit signals 1050 that span entire respective transmission windows 1045. Each transmission window 1045 has a duration equal to T_{Data} plus T_{Pad}. The PMA 1006 provides the transmit signals 1050 to the PMD 1008, which converts them to analog and drives them onto a coax link. Because the PHY of FIG. 10A uses FDD, the transmission windows 1045 follow each other without interruption: the dedicated upstream and downstream frequency bands in FDD allow for continuous transmission in each direction. (If the PHY of FIG. 10A is implemented in a CNU 140, however, it will only transmit continuously across successive windows 1045 if the successive windows 1045 have been allocated to it.)

The baud rates R_{PCS,TX} and R_{PMA} are related as follows:

$${R}_{PCS , TX} = {R}_{PMA} \times \frac{{T}_{Data}}{{T}_{Data} + {T}_{Pad}} . \qquad ( 3 )$$

Equation (1) shows that R_{PCS,TX} is a fraction of R_{PMA} as determined by the ratio of T_{Data} to the duration of an entire transmission window 1045.

The PHY of FIG. 10A operates similarly in the inbound direction. Receive signals are received during successive, uninterrupted reception windows. The PMA 1006 converts the receive signals into a receive bitstream that includes packets separated by idle characters, and inserts pad bits to separate the data received in different reception windows. The data in the receive bitstream thus is divided into time slices separated by pad bits. The PMA 1006 provides this bitstream to the rate adapter 1004 at the rate R_{PMA}, which is the same rate R_{PMA} as in the outbound direction. The rate adapter 1004 therefore provides a fixed-rate, bi-directional interface between the PMA 1006 and the upper PCS layers 510. The rate adapter 1004 removes the pad bits, adapts the rate of the bitstream to a rate R_{PCS,RX}, and provides the resulting rate-adapted bitstream to the upper PCS layers 510, which process the bitstream as described with respect to FIG. 6B.

The rate R_{PCS,RX} is calculated using an equation with the form of equation (3). However, R_{PCS,RX} may be different from R_{PCS,TX}, for example because of asymmetric bandwidth between the upstream and downstream directions. In some embodiments, fewer sub-carriers are available in the upstream direction than in the downstream direction, resulting in less upstream bandwidth than downstream bandwidth. As a result, R_{PCS,RX} in a CLT 162 is less than R_{PCS,TX} in the CLT 162. (The difference between R_{PCS,RX} and R_{PCS,TX} causes the relative values of T_{Data} and T_{Pad} for outbound processing to differ from the relative values of T_{Data} and T_{Pad} for in-bound processing.) However, R_{PMA} is constant with the same value in both directions.

In some embodiments, the PHY of FIG. 10A is configurable to use TDD in a first mode of operation and FDD in a second mode of operation. For example, in FDD mode the rate adapter 1004, PMA 1006, and PMD 1008 are configured to function as described with respect to FIGS. 10A and 10B, while in TDD mode the rate adapter 1004, PMA 1006, and PMD 1008 are configured to function as the TDD adapter 512, PMA 514, and PMD 516 of FIGS. 5A-5B and 6A-6B.

In some embodiments, a PHY that is configurable to use TDD in a first mode of operation and FDD in a second mode of operation includes a rate adapter in its PMD (e.g., instead of in its PCS). Examples of such a PHY are shown below in FIGS. 11A-11B, 12A-12B, 13A-13B, and 14A-14B.

In FIG. 11A, a PHY (e.g., coax PHY 308 or 318, FIG. 3) includes a PCS 1108, a PMA 1110, and a PMD 1112. The PCS 1108 is coupled to the full-duplex MAC 502 (e.g., MAC 304 or 314, FIG. 3) through the media independent interface 506 and RS 504 (FIGS. 5A and 6A). The media-independent interface 506 simultaneously conveys a first continuous transmit bitstream from the full-duplex MAC 502 to the PCS 1108 and a second continuous bitstream from the PCS 1108 to the full-duplex MAC 502. The PMD 1112 includes a coax rate adapter 1114 and one or more lower PMD layers 1116.

In some embodiments, the PHY of FIG. 11A, including the PCS 1108, PMA 1110, PMD 1112, and the PHY's portion of the xMII 506, is implemented in hardware in a single integrated circuit. The full-duplex MAC 502 may be implemented in a separate integrated circuit or the same integrated circuit.

FIG. 11B is aligned with FIG. 11A to show downstream (or, more generally, outbound) signals provided between the various sublayers of FIG. 11A. The signals of FIG. 11B correspond to the solid downward arrows of FIG. 11A. The full-duplex MAC 502 transmits a continuous bitstream 520 (FIG. 5B) across the media-independent interface 506 to the PCS 1108. The media-independent interface 506 runs at a fixed rate R_{xMII}. The bitstream 520 includes data frames 522 and idle frames 524; the idle frames 524 are included in the bitstream 520 to maintain the fixed rate R_{xMII}. In some embodiments the frames 522 and 524 are Ethernet frames. (The frames described with respect to FIGS. 11B, 12B, 13B, and 14B include packets and thus may also be referred to as packets, in accordance with FIGS. 5B and 6B.)

The PCS 1108 removes the idle frames 524 and performs an FEC encoding process that inserts parity bits in the data frames, resulting in a mixture of data and parity bits (D+P). For example, the PCS 1108 generates encoded data frames (D+P) 1132 separated by idle characters 1134 that fill the inter-frame gaps and act as frame separators. In some embodiments, the PCS 1108 deletes from the bitstream 520 some idle characters of the idle frames 524, leaving other idle characters 1134 to fill the inter-frame gaps between the data frames 1132. The PCS 1108 may perform stream-based FEC encoding on the data and remaining idle characters of the bitstream 520, producing parity bits that take the place of the deleted idle characters. Alternatively, the PCS 1108 performs block-based FEC encoding. The PCS 1108 generates a bitstream 1130 in which the encoded data frames 1132 and idle characters 1134 are grouped into bursts. The PCS 1108 inserts pad bits 1136 into the bitstream 1130; the pad bits 1136 separate respective bursts. (Alternatively, instead of inserting pad bits 1136, the PCS 1108 leaves gaps in the bitstream 1130, such that the bitstream 1130 is not continuous.) In some embodiments, the pad bits 1136 (or alternatively, the gaps) have a fixed length (i.e., duration) T_{PAD} and the bursts have a fixed length (i.e., duration) T_{BURST}. In other embodiments, the values of T_{PAD} and T_{BURST} vary about fixed averages and the PCS 1108, PMA 1110, and/or PMD 1112 perform buffering to accommodate this variation.

The PCS 1108 provides the bitstream 1130 to the PMA 1110 at a rate R_{PCS} that equals the rate R_{xMII}. The PMA 1110 processes the bitstream 1130 (e.g., in accordance with IEEE 802.3 standards) and forwards the bitstream 1130 to the PMD 1112 at a rate R_{PMA} that equals the rates R_{xMII} and R_{PCS}. The xMII 506, PCS 1108, and PMA 1110 thus all operate at the same rate.

(The term “bitstream” as used herein includes all signals described as such that are transmitted between respective PHY sublayers as shown in the figures. It therefore is apparent that the term “bitstream” may include streams of samples and/or streams of symbols as well as streams of individual bits.)

The coax rate adapter 1114 of the PMD 1112 receives the bitstream 1130 from the PMA 1110 at the rate R_{PMA} and adapts it to a lower rate R_{PMD,TX}, resulting in a bitstream 1140 with data frames 1142 and idle character separators 1144. The rates R_{PMD,TX} and R_{PMA} are related as follows:

$${R}_{PMD , TX} = {R}_{PMA} \times \frac{{T}_{BURST}}{{T}_{PAD} + {T}_{BURST}} \qquad ( 4 )$$

where T_{PAD} and T_{BURST} are either the fixed or average lengths of the pad bits 1136 and bursts, respectively.

The one or more lower PMD layers 1116 of the PMD 1112 convert the bitstream 1140 into transmit signals 1150 that are transmitted onto a coax link (e.g., coax link 310, FIG. 3). The transmit signals 1150 span entire respective transmission windows 1152. In some embodiments, each transmission window 1152 has a duration equal to the (fixed or average) values T_{PAD} plus T_{BURST}. In some embodiments, the start of a transmission window 1152 is aligned with the end of a sequence of pad bits 1136 or with the start of a burst. Alternatively, transmission windows 1152 are not aligned with sequences of pad bits 1136 or with bursts. Because the PHY of FIG. 11A is operating in the second mode and thus performing FDD, the transmission windows 1152 follow each other without interruption: the dedicated upstream and downstream frequency bands in FDD allow for continuous transmission in each direction. (If the PHY of FIG. 11A is implemented in a CNU 140, however, it will only transmit continuously across successive transmission windows 1152 if the successive transmission windows 1152 have been allocated to it.)

In the second mode, the PHY of FIG. 11A receives data using FDD by reversing the process described with respect to FIG. 11B. Signals are received during successive, uninterrupted reception windows. The lower PMD layers 1116 convert the receive signals into a receive bitstream that includes data frames separated by idle characters. The receive bitstream is provided at a rate R_{PMD,RX} to the coax rate adapter 1114, which adapts the bitstream to the higher rate R_{PMA} and inserts pad bits (or gaps) between bursts of data frames and idle characters. The resulting bitstream is provided to the PMA 1110 at the rate R_{PMA}, processed by the PMA 1110, and forwarded to the PCS 1108 at the rate R_{PCS}=R_{PMA}. The PCS 1108 performs decoding, removes the parity bits, removes the pad bits (or gaps), and inserts idle frames, resulting in a continuous bitstream that is forwarded to the RS 504 and full-duplex MAC 502 at the rate R_{xMII}=R_{PCS}=R_{PMA}.

The rate R_{PCS,RX} is calculated using an equation with the form of equation (4). However, R_{PCS,RX} may be different from R_{PCS,TX}, for example because of asymmetric bandwidth between the upstream and downstream directions. In some embodiments, fewer sub-carriers are available in the upstream direction than in the downstream direction, resulting in less upstream bandwidth than downstream bandwidth. As a result, R_{PCS,RX} is less than R_{PCS,TX} in the CLT 162 and is greater than R_{PCS,TX} in a CNU 140. (The difference between R_{PCS,RX} and R_{PCS,TX} causes the relative values of T_{BURST} and T_{PAD} for transmission to differ from the relative values of T_{BURST} and T_{PAD} for reception.) However, R_{PMA} is constant with the same value in both directions in accordance with some embodiments.

An example of TDD transmissions in the coax PHY 308 or 318 (FIG. 3) in the first mode is now provided with reference to FIGS. 12A and 12B. FIG. 12A shows the same PHY and full-duplex MAC 502 as FIG. 11A, but the PHY is now configured in the first mode. FIG. 12B is aligned with FIG. 12A to show signals provided between the various sublayers of FIG. 12A; the signals of FIG. 12B correspond to the solid downward arrows of FIG. 12A. The full-duplex MAC 502, RS 504, xMII 506, PCS 1108, and PMA 1110 function as described with respect to FIGS. 11A and 11B.

The coax rate adapter 1114 receives the bitstream 1130 from the PMA 1110 at the rate R_{PMA}, removes the pad bits 1136, adapts the encoded data frames 1132 and separators 1134 to a lower rate R_{PMD,TX}, and periodically inserts gaps 1208. The result is a bitstream 1202 with data frames 1204 and idle character separators 1206. The data frames 1204 and separators 1206 between two gaps 1208 have a total length (i.e., duration) of T_{DATA}. T_{DATA} matches the length T_{TX} of a transmission window 1212 in a TDD Cycle T_{C} in which the PHY of FIG. 12A can transmit (e.g., a downstream window 202 or 208 for a CLT 162, or an upstream window 206 or 212 for a CNU 140). Successive transmission windows 1212 are separated by times 1214 during which the PHY of FIG. 12A does not transmit (e.g., a combination of guard intervals and windows during which the PHY is configured to receive data, such as upstream windows in the CLT 162 and downstream windows in a CNU 140). The rates R_{PMD,TX} and R_{PMA} are related as follows:

$${R}_{PMD , TX} = {R}_{PMA} \times \frac{{T}_{BURST}}{{T}_{DATA}} . \qquad ( 5 )$$

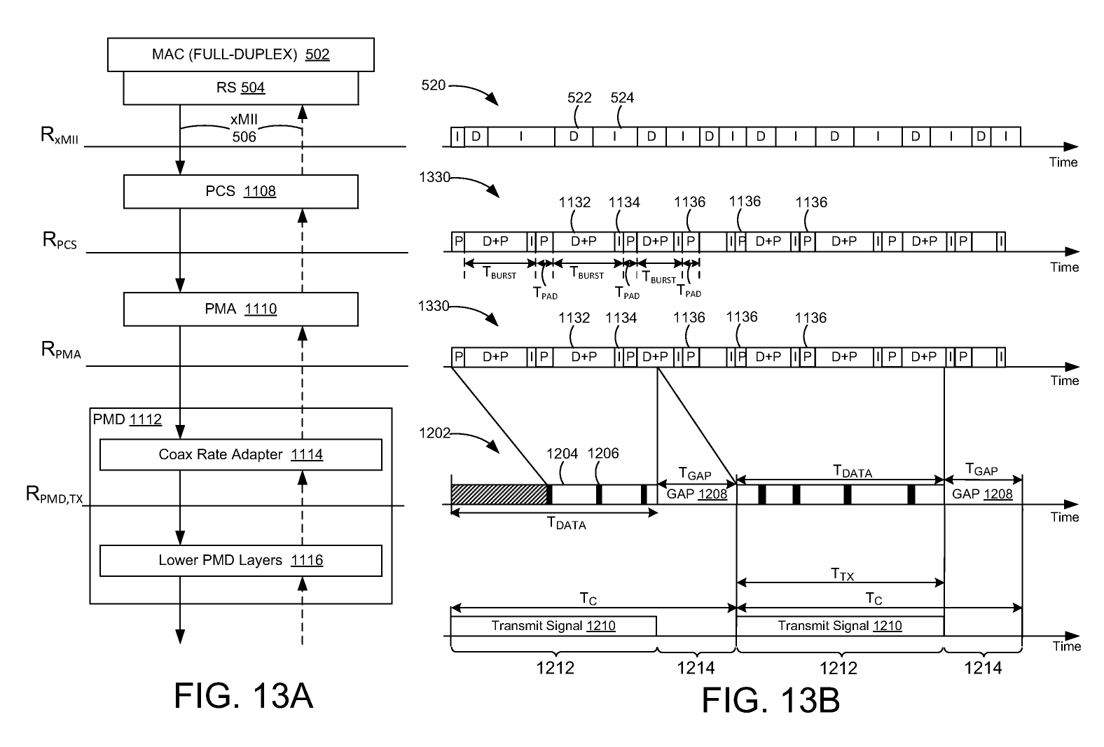

In some embodiments, T_{BURST} may be substantially shorter than T_{DATA}. For example, a burst may be a single FEC code word (e.g., in embodiments using stream-based FEC) or a single frame (e.g., a single Ethernet frame). Furthermore, the period T_{BURST}+T_{PAD} may be less than the period T_{DATA}+T_{GAP}. Also, the values of T_{BURST}, T_{PAD}, and T_{BURST}+T_{PAD} may vary (e.g., about fixed averages). FIGS. 13A and 13B illustrate an example in which T_{BURST} is less than T_{DATA}, T_{BURST}+T_{PAD} is less than T_{DATA}+T_{GAP}, and the values of T_{BURST}, T_{PAD}, and T_{BURST}+T_{PAD} vary. The bitstream 1330 of FIG. 13B is an example of the bitstream 1130 of FIGS. 11B and 12B. In this example, the rates R_{PMD,TX} and R_{PMA} are related as follows:

$${R}_{PMD , TX} = {R}_{PMA} \times \frac{{T}_{BURST}}{{T}_{DATA}} \times \frac{{T}_{DATA} + {T}_{GAP}}{{T}_{BURST} + {T}_{PAD}} . \qquad ( 6 )$$

The coax rate adapter 1114 converts the bitstream 1330 into the bitstream 1202.

The one or more lower PMD layers 1116 convert the data frames 1204 in the bitstream 1202 into transmit signals 1210 that are transmitted onto a coax link (e.g., coax link 310, FIG. 3) during transmission windows 1212 of duration T_{TX}. The gaps 1208 correspond to times 1214 between transmission windows 1212. The start of a transmission window 1212 may be aligned with the end of a sequence of pad bits 1136 or with the start of a burst, but is not necessarily so aligned.

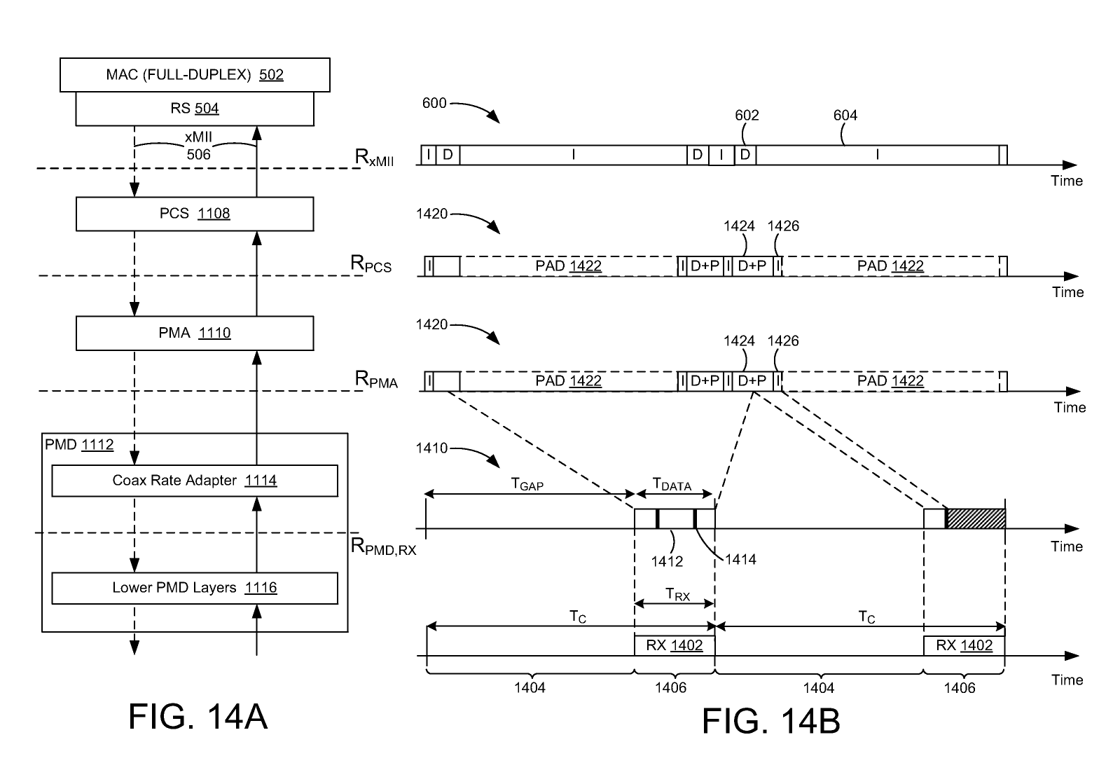

An example of TDD operation for data reception is now provided with reference to FIGS. 14A and 14B. FIG. 14A shows the same PHY and full-duplex MAC 502 as FIGS. 11A, 12A, and 13A, with the PHY configured in the first mode. FIG. 14B is aligned with FIG. 14A to show signals provided between the various sublayers of FIG. 14A. The signals of FIG. 14B correspond to the solid upward arrows of FIG. 14A. The one or more lower PMD layers 1116 receive signals 1402 during reception windows 1406 of duration T_{RX} (e.g., downstream windows 202 and 208 for a CNU 140 or upstream windows 206 and 212 for a CLT 162). Successive reception windows 1406 are separated by times 1404 during which the PHY of FIG. 14A does not receive data (e.g., a combination of guard intervals and transmission windows, such as downstream windows in the CLT 162 and upstream windows in a CNU 140). The lower PMD layers 1116 convert the receive signals 1402 into a bitstream 1410 that includes data frames 1412 and idle character separators 1414 in time periods T_{DATA} that are separated by gaps of duration T_{GAP}. The data frames 1412 are encoded and include parity bits. T_{DATA} corresponds to T_{RX} and T_{GAP} corresponds to the times 1404. The bitstream 1410 is provided to the coax rate adapter 1114 at a rate R_{PMD,RX}, which may be calculated using an equation analogous to Equation (5) or (6) but may differ from R_{PMD,TX} due to asymmetry between upstream and downstream bandwidth.

The coax rate adapter 1114 inserts pad bits 1422 (or alternatively leaves gaps) in the bitstream 1410, resulting in a bitstream 1420 that is provided to the PMA 1110 at a rate R_{PMA}. In addition to the pad bits 1422, the bitstream 1420 includes encoded data frames 1424 and idle character separators 1426 that correspond respectively to the data frames 1412 and separators 1414. The PMA 1110 processes the bitstream 1420 (e.g., in accordance with IEEE 802.3 standards) and forwards the bitstream 1420 to the PCS 1108 at the rate R_{PCS}=R_{PMA}.

The PCS 1108 decodes the data frames 1424 and removes the parity bits, resulting in data frames 602. The PCS 1108 also removes the pad bits 1422 and inserts idle frames 604, resulting in a bitstream 600 (FIG. 6B). The bitstream 600 is transmitted across the xMII 506 to the RS 504 and full-duplex MAC 502 at the rate R_{xMII}, which equals R_{PCS} and R_{PMA}. Furthermore, these rates may be the same as the corresponding rates for data transmission as described with respect to FIGS. 12A and 12B.

FIGS. 11A-11B, 12A-12B, 13A-13B, and 14A-14B thus illustrate another example of both TDD and FDD functionality in a PHY coupled to a full-duplex MAC 502. Furthermore, the PCS 1108 and PMA 1110 operate at a constant rate.

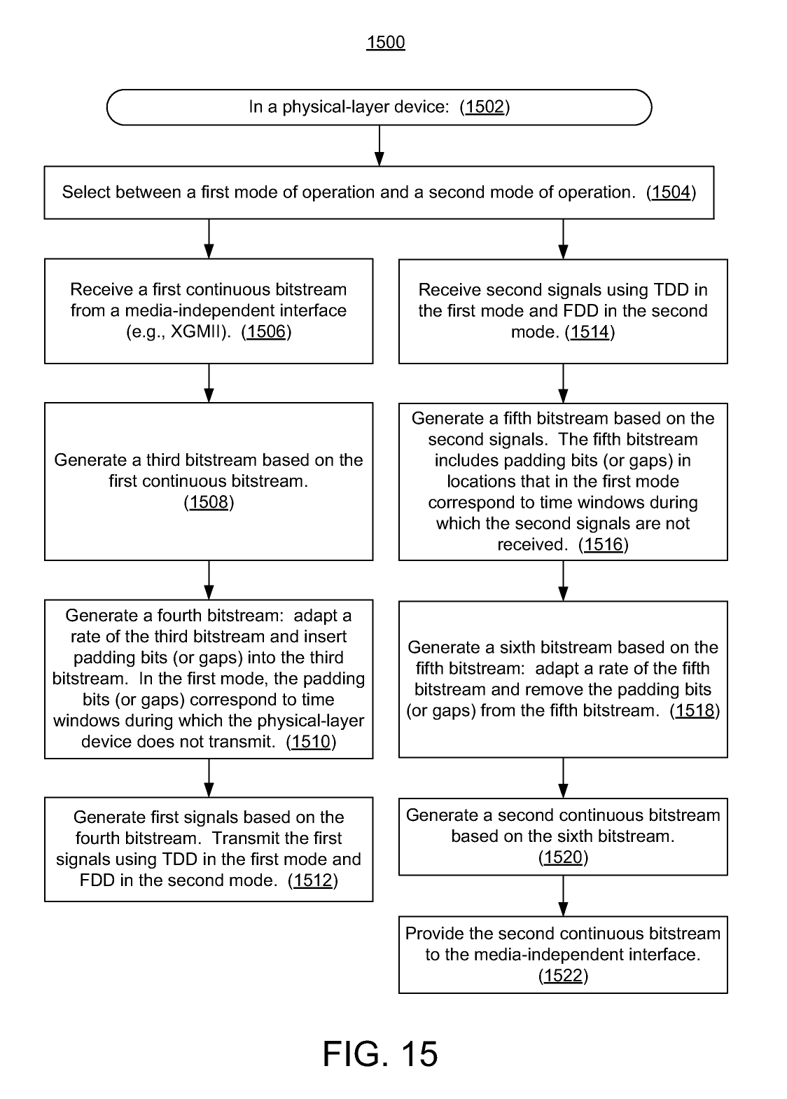

FIG. 15 is a flowchart showing a method 1500 of data communications in accordance with some embodiments. The method 1500 is performed (1502) in a PHY, such as the coax PHY 308 or 318 (FIG. 3); the PHY of FIGS. 5A, 6A, and 10A; or the PHY of FIGS. 11A, 12A, 13A, and 14A. In some embodiments, the PHY in which the method 1500 is performed includes PCS, PMA, and PMD sublayers.

In the method 1500, a selection is made (1504) between a first mode of operation and a second mode of operation. If the first mode is selected, the PHY is configured for TDD operation. If the second mode is selected, the PHY is configured for FDD operation.

A first continuous bitstream is received (1506) from a media-independent interface. Examples of the first continuous bitstream include the bitstream 400 (FIG. 4) and the bitstream 520 (FIGS. 5B, 10B, 11B, 12B, and 13B). Examples of the media-independent interface include interface 306 or 316 (FIG. 3) and xMII 506 (FIGS. 5A, 6A, 10A, 11A, 12A, 13A, and 14A). In some embodiments, the media-independent interface is an XGMII operating at 10 Gbps.

A third bitstream (e.g., bitstream 530, FIGS. 5B and 10B; bitstream 1130, FIGS. 11B and 12B, or bitstream 1330, FIG. 13B) is generated (1508) based on the first continuous bitstream. In some embodiments, generating the third bitstream includes encoding data in the first continuous bitstream and deleting idle characters from the first continuous bitstream.

A fourth bitstream (e.g., bitstream 540, FIGS. 5B and 10B; bitstream 1140, FIG. 11B, or bitstream 1202, FIGS. 12B and 13B) is generated (1510) based on the third bitstream. To generate the fourth bitstream, the rate of the third bitstream is adapted and pad bits (e.g., pad bits 546, FIGS. 5B and 10B) or gaps (e.g., gaps 1208, FIGS. 12B and 13B) are inserted into the third bitstream. In some embodiments, pad bits are inserted into the third bitstream in both the first and second modes. In some other embodiments, gaps are inserted into the third bitstream in the first mode but not in the second mode. In the first mode, the pad bits or gaps correspond to time windows during which the PHY does not transmit.

In some embodiments, the third and fourth bitstreams are generated in the PCS (e.g., as shown in FIGS. 5B and 10B). Alternatively, the third bitstream is generated in the PCS and the fourth bitstream is generated in the PMD (e.g., as shown in FIGS. 11B, 12B, and 13B).

First signals are generated (1512) based on the fourth bitstream and transmitted. In the first mode, the first signals are transmitted using TDD; in the second mode, the first signals are transmitted using FDD. Examples of the first signals in the first mode include downstream signals 550 (FIG. 5B) and transmit signals 1210 (FIGS. 12B and 13B). Examples of the first signals in the second mode include transmit signals 1050 (FIG. 10B) and transmit signals 1150 (FIG. 11B). Because the bitstream from which the first signals are generated is ultimately based on the first continuous bitstream, the first signals correspond to the first continuous bitstream.

Also in the method 1500, second signals are received (1514) using TDD in the first mode and FDD in the second mode. Examples of the second signals in the first mode include upstream signals 630 (FIG. 6B) and receive signals 1402 (FIG. 14B). Examples of the second signals in the second mode include receive signals that are received across entire transmission windows 1045 (FIG. 10B) or 1152 (FIG. 11B). (For FDD in the second mode, the transmission windows 1045 or 1152 are also reception windows, since transmission and reception occur simultaneously.)

A fifth bitstream (e.g., bitstream 620, FIG. 6B; bitstream 1410, FIG. 14B) is generated (1516) based on the second signals. The fifth bitstream includes pad bits (e.g., pad bits 622, FIG. 6B) or gaps (e.g., of duration T_{Gap} in the bitstream 1410, FIG. 14B) in locations that in the first mode correspond to time windows during which the PHY does not receive the second signals. In some embodiments, the fifth bitstream includes the pad bits in both the first and second modes. In some other embodiments, the fifth bitstream includes the gaps in the first mode but not in the second mode.

A sixth bitstream (e.g., bitstream 610, FIG. 6B; bitstream 1420, FIG. 14B) is generated (1518) based on the fifth bitstream. Generating the sixth bitstream includes adapting a rate of the fifth bitstream and removing the pad bits or gaps from the fifth bitstream.

In some embodiments, the fifth bitstream is generated in the PMA and the sixth bitstream is generated in the PCS (e.g., as shown in FIG. 6B). Alternatively, the fifth bitstream and sixth bitstream are both generated in the PMD (e.g., as shown in FIG. 14B).

A second continuous bitstream (e.g., bitstream 600, FIG. 6B or 14B) is generated (1520) based on the sixth bitstream. In some embodiments, generating the second continuous bitstream includes decoding data in the sixth bitstream and adding idle characters to the sixth bitstream. In some embodiments, the second continuous bitstream is generated in the PCS. Because the sixth bitstream is ultimately based on the second signals, the second continuous bitstream corresponds to the second signals.

The second continuous bitstream is provided (1522) to the media-independent interface.

While the method 1500 includes a number of operations that appear to occur in a specific order, it should be apparent that the method 1500 can include more or fewer operations, which can be executed serially or in parallel. An order of two or more operations may be changed, performance of two or more operations may overlap, and two or more operations may be combined into a single operation. For example, the operations 1506, 1508, 1510, 1512, 1514, 1516, 1518, 1520, and 1522 may be performed simultaneously in an ongoing manner.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A physical-layer device, comprising:
a first sublayer to receive a first continuous bitstream from a media-independent interface and to provide a second continuous bitstream to the media-independent interface; and
a second sublayer to transmit first signals corresponding to the first continuous bitstream and to receive second signals corresponding to the second continuous bitstream;
wherein the second sublayer is to transmit the first signals and receive the second signals using time-division duplexing in a first mode of operation and using frequency-division duplexing in a second mode of operation.

2. The physical-layer device of claim 1, wherein:
in the first mode, the second sublayer is to transmit the first signals during a first plurality of time windows and receive the second signals during a second plurality of time windows distinct from the first plurality of time windows; and
in the second mode, the second sublayer is to transmit the first signals and receive the second signals simultaneously on different frequency bands.

3. The physical-layer device of claim 1, wherein:
the first sublayer comprises a physical coding sublayer (PCS);
the second sublayer comprises a physical medium-dependent sublayer (PMD); and
the physical-layer device further comprises a physical medium attachment sublayer (PMA) coupled between the PCS and the PMD.

4. The physical-layer device of claim 3, wherein the PCS comprises:
one or more layers to encode data in the first continuous bitstream and delete idle characters from the first continuous bitstream, to generate a third bitstream; and
a rate adapter, coupled between the one or more layers and the PMA, to generate a fourth bitstream by adapting a rate of the third bitstream and adding pad bits to the third bitstream, wherein in the first mode the pad bits correspond to time windows during which the PMD does not transmit the first signals.

5. The physical-layer device of claim 4, wherein the PMA is to generate the first signals based on the fourth bitstream.

6. The physical-layer device of claim 3, wherein:
the PMA is to generate a fifth bitstream based on the second signals, the fifth bitstream comprising pad bits that in the first mode correspond to time windows during which the PMD does not receive the second signals; and
the PCS comprises a rate adapter to adapt a rate of the fifth bitstream and remove the pad bits from the fifth bitstream, to generate a sixth bitstream.

7. The physical-layer device of claim 6, wherein the PCS further comprises one or more layers to decode data in the sixth bitstream and add idle characters to the sixth bitstream, to generate the second continuous bitstream.

8. The physical-layer device of claim 3, wherein:
the PCS is to encode data in the first continuous bitstream and delete idle characters from the first continuous bitstream, to generate a third bitstream; and
the PMD comprises a rate adapter to generate a fourth bitstream by adapting a rate of the third bitstream and, in the first mode, adding gaps to the third bitstream corresponding to time windows during which the PMD does not transmit the first signals.

9. The physical-layer device of claim 8, wherein the PMD further comprises one or more layers to generate the first signals based on the fourth bitstream.

10. The physical-layer device of claim 3, wherein the PMD comprises:
one or more layers to generate a fifth bitstream based on the second signals, wherein, in the first mode, the fifth bitstream includes gaps corresponding to time windows during which the PMD does not receive the second signals; and
a rate adapter to generate a sixth bitstream by adapting a rate of the fifth bitstream and, in the first mode, removing the gaps from the fifth bitstream.

11. The physical-layer device of claim 10, wherein the PCS is to decode data in the sixth bitstream and add idle characters to the sixth bitstream, to generate the second continuous bitstream.

12. A method of data communications, comprising:
in a physical-layer device:
selecting between a first mode of operation and a second mode of operation;
receiving a first continuous bitstream from a media-independent interface;
providing a second continuous bitstream to the media-independent interface;
when the first mode is selected, transmitting first signals corresponding to the first continuous bitstream and receiving second signals corresponding to the second continuous bitstream using time-division duplexing; and
when the second mode is selected, transmitting the first signals and receiving the second signals using frequency-division duplexing.

13. The method of claim 12, wherein:
transmitting the first signals and receiving the second signals using time-division duplexing comprises transmitting the first signals during a first plurality of time windows and receiving the second signals during a second plurality of time windows distinct from the first plurality of time windows; and
transmitting the first signals and receiving the second signals using frequency-division duplexing comprises transmitting the first signals and receiving the second signals simultaneously on different frequency bands.

14. The method of claim 12, further comprising:
generating a third bitstream based on the first continuous bitstream, comprising encoding data in the first continuous bitstream and deleting idle characters from the first continuous bitstream;
generating a fourth bitstream based on the third bitstream, comprising adapting a rate of the third bitstream and adding pad bits to the third bitstream, wherein in the first mode the pad bits correspond to time windows during which the physical-layer device does not transmit the first signals; and
generating the first signals based on the fourth bitstream.

15. The method of claim 14, wherein:
the physical-layer device comprises PCS, PMA, and PMD sublayers; and
generating the third and fourth bitstreams is performed in the PCS.

16. The method of claim 12, further comprising:
generating a fifth bitstream based on the second signals, the fifth bitstream comprising pad bits that in the first mode correspond to time windows during which the physical-layer device does not receive the second signals;
generating a sixth bitstream based on the fifth bitstream, comprising adapting a rate of the fifth bitstream and removing the pad bits from the fifth bitstream; and
generating the second continuous bitstream based on the sixth bitstream, comprising decoding data in the sixth bitstream and adding idle characters to the sixth bitstream.

17. The method of claim 16, wherein:
the physical-layer device comprises PCS, PMA, and PMD sublayers; and
generating the sixth and second continuous bitstreams is performed in the PCS.

18. The method of claim 12, further comprising:
generating a third bitstream based on the first continuous bitstream, comprising encoding data in the first continuous bitstream and deleting idle characters from the first continuous bitstream;
generating a fourth bitstream based on the third bitstream, comprising adapting a rate of the third bitstream and, in the first mode, adding gaps to the third bitstream corresponding to time windows during which the physical-layer device does not transmit the first signals; and
generating the first signals based on the fourth bitstream.

19. The method of claim 18, wherein:
the physical-layer device comprises PCS, PMA, and PMD sublayers;
generating the third bitstream is performed in the PCS; and
generating the fourth bitstream is performed in the PMD.

20. The method of claim 12, further comprising:
generating a fifth bitstream based on the second signals, wherein in the first mode the fifth bitstream includes gaps corresponding to time windows during which the physical-layer device does not receive the second signals;
generating a sixth bitstream based on the fifth bitstream, comprising adapting a rate of the fifth bitstream and, in the first mode, removing the gaps from the fifth bitstream; and
generating the second continuous bitstream based on the sixth bitstream, comprising decoding data in the sixth bitstream and adding idle characters to the sixth bitstream.

21. The method of claim 20, wherein:
the physical-layer device comprises PCS, PMA, and PMD sublayers;
generating the fifth and sixth bitstream is performed in the PMD; and
generating the second continuous bitstream is performed in the PCS.

22. A physical-layer device, comprising:
means for receiving a first continuous bitstream from a media-independent interface and providing a second continuous bitstream to the media-independent interface; and
means for transmitting first signals corresponding to the first continuous bitstream and receiving second signals corresponding to the second continuous bitstream using time-division duplexing in a first mode of operation and using frequency-division duplexing in a second mode of operation.
